(19) United States
(12) Patent Application Publication
(10) Pub. No.: US 2013/0047261 A1
(43) Pub. Date: Feb. 21, 2013

(54) Data Access Control

(71) Applicants: Graeme John Proudler, Bristol (GB); Chris I. Dalton, (US)

(72) Inventors: Graeme John Proudler, Bristol (GB); Chris I. Dalton, (US)

(21) Appl. No.: 13/213,959

(22) Filed: Aug. 19, 2011

(51) Int. Cl. G06F 21/24

(52) U.S. Cl. 726/27

(57) ABSTRACT

A set of data is provided to an application executed in an environment within which the application is restricted from making its output available outside the environment. An operation performed on the set of data by the application is inspected. A determination of whether an output of the application is satisfactory is reached based on the inspection. If the output is determined satisfactory, the output of the application is made available outside the environment.

### BACKGROUND

As the Internet gains popularity, more and more services are made available online. Due to privacy and security concerns, users are often reluctant to grant online service providers access to users' private information, even if such information may be helpful for the service providers to provide the services.

### BRIEF DESCRIPTION OF THE DRAWINGS

FIG. 1 is a diagram of an example of a network environment for a data access control system.

FIG. 2 is a diagram of an example of a method for the system shown in FIG. 1 to prevent a software application from misusing private data.

FIG. 3 is a block diagram illustrating an example process of the system shown in FIG. 1.

FIG. 4 is a diagram of an example of a computer system.

### DETAILED DESCRIPTION

The present subject matter is now described more fully with reference to the accompanying figures, in which several examples are shown. The present subject matter may be embodied in many different forms and should not be construed as limited to the examples set forth herein. Rather these examples are provided so that this disclosure will be complete and will fully convey principles of the subject matter.

### Example Network Environment

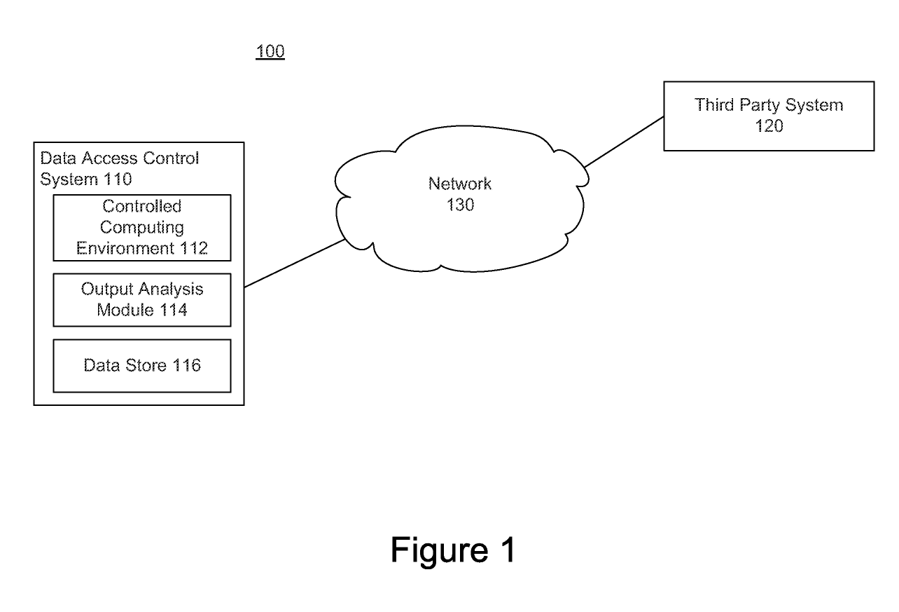

FIG. 1 illustrates one example of a network environment 100 for a data access control system 110 (e.g., to prevent a software application from misusing private data). The network environment 100 includes the data access control system 110 and a computer system 120, both connected through a network 130. One of each type of entity is illustrated for clarity.

The data access control system 110 is a computer system that prevents a software application from misusing private data by inspecting results of operations performed by the software application on the private data, and only making outputs of the software application available over the network 130 if the outputs are satisfactory. The software application and the private data are provided to the data access control system 110 by an application provider (e.g., the computer system 120) and a data owner (e.g., a user of the data access control system 110), respectively. The software application may be provided along with a corresponding specification including information such as an identity of data used by the application, the purpose of the application, an identity of data outputted by the application, transformation operations performed on the data, and/or an output format. In such implementations, the specification provided may be in a format and/or grammar that can be interpreted by the data access control system 110 (e.g., Extensible Markup Language (XML)). An example specification for a flight reservation application is illustrated below.

< Input Data>

Departing_City, Arriving_City, Departing_Date, Returning_Date

</Input Data>
<Purpose>

Make Flight Reservation

</Purpose>
<Transformation Operation>

Convert Cities to Airport Codes
Convent Dates to YYYY-MM-DD Format

</ Transformation Operation>
<Output Data>

Departing_Airport_Code(s), Arriving_Airport_Code(s),
Formatted_Departing_Date, Formatted_Returning_Date

</Output Data>

In one example, before a software application is executed in the data access control system 110 or before the application accesses any private data residing in the data access control system 110, the specification of that software application is examined (e.g., by the data owner and/or by an authorizing application). For example, if the data owner has reviewed and approved the specification, or has previously approved the specified transformation operations for the specified purpose, the data access control system 110 executes the application to operate on the private data. As another example, an authorizing application has knowledge of transformation operations (e.g., duplication operations (e.g., copying), aggregation operations (e.g., merging), derivation operations (e.g., abstracting), cryptographic operations (e.g., hashing), indirection operations (e.g., generating reference value pointing to the private data)) applicable to different types of private data. For example, the authorizing application may know that financial data (e.g., credit card numbers) are subject to cryptographic operations and preference data (e.g., preferred hotel chains) are subject to less stringent operations such as the aggregation operations. The authorization application can use its knowledge to analyze the specification to determine whether the specification is satisfactory (e.g., the transformation operations to be applied to the type of data are consistent to the knowledge). If the specification is found satisfactory, then the software application is executed in the data access control system 110 and/or is allowed to access the private data.

The data access control system 110 includes a controlled computing environment 112, an output analysis module 114, and a data store 116. The controlled computing environment 112 is a trusted computing environment that can provide assurance of appropriate trust and/or security to providers of software applications executed thereon and/or owners of data accessed by such applications. To assure the trustworthiness of the environment, the environment 112 provides an integrity measurement process of obtaining integrity metric measurements (e.g., measurements of characteristics that affect the integrity/trustworthiness of the environment). Because the assurance indicates that applications executing in the environment 112 are not subject to misuse, application providers may be more willing to provide (or develop) applications to be executed in the environment 112. In addition, the environment 112 restricts applications executed thereon from making outputs available outside the environment 112 (e.g., restricting the applications from communicating with entities outside the environment 112).

One example of the controlled computing environment 112 is a trusted computer system that includes a tamper-resistant trusted entity component. The trusted entity component uses cryptographic processes to create a computing environment that is substantially immune to unauthorized modification and to securely enforce various security control policies. Another example of the environment 112 is a trusted platform that includes core software (e.g., Basic Input/Output System (BIOS), operating system) supporting multiple virtualized computing environments, each of which may have a separate virtual trusted entity component to securely enforce security control policies in the respective environment. The environment 112 may be implemented in a cloud computing environment.

The output analysis module 114 verifies the trustworthiness of a software application executing in the controlled computing environment 112 by ensuring that the operations and/or outputs of the software application are consistent with the corresponding specification. Specifically, the output analysis module 114 retrieves the data accessed by the software application (or identified in the specification) and the output data of the application, and verifies the transformations specified in the application specification. For example, if a specified transformation operation is copying, the output data should contain a copy of the accessed data; if a specified transformation operation is aggregation, the output data should include merged accessed data; if a specified transformation operation is a stated derivation, the output data should be that derivation of the accessed data; if a specified transformation operation is cryptographic, the output data should appear to be random and may include information about cryptographic processes and items such as cryptographic keys; if a specified transformation operation is indirection, the output data should be a means of obtaining the accessed data. If the outputs are consistent with the specified transformations, then the output analysis module 114 determines that the operations/outputs of the software application are consistent with the specification. Additionally or alternatively, the output analysis module 114 can provide the application outputs to the owner of the data accessed by the software application for approval. If the operations/outputs of the software application are consistent with the specification, and/or the data owner approved the application outputs, the output analysis module 114 determines that the application outputs are satisfactory and makes the outputs available outside the controlled computing environment 112. For example, the output analysis module 114 enables the software application executed within the controlled computing environment 112 to communicate with the computer system 120 outside the environment 112. Otherwise, the output analysis module 114 can prohibit the software application from communicating with entities outside the controlled computing environment 112, and can rollback operations performed by the software application on the accessed data (e.g., by erasing the application's output data and/or restoring an earlier version of the data in the controlled computing environment 112).

The data store 116 stores data used by the data access control system 110. Examples of the data stored in the data store 116 include private data/software applications that are used/executed in the controlled computing environment 112, application specifications, and application outputs. The data store 116 may be a database stored on a non-transitory computer-readable storage medium.

The computer system 120 is a computer system that provides a service over the network 130. The computer system 120 provides a front-end application that can be downloaded by the data access control system 110 and executed in the controlled computing environment 112. The front-end application accesses user data in the controlled computing environment 112 and communicates with a back-end application executed in the computer system 120 to provide the service. The computer system 120 may provide a specification of the front-end application together with the application (e.g., in one package). In addition, the computer system 120, the back-end application, and/or the front-end application (e.g., executing in an environment outside the data access control system 110) may be configured to verify the trustworthiness of the computing environment 112 (e.g., by requesting and/or examining an integrity metric measurement from the computing environment 112) before the front-end application is executed inside the computing environment 112.

The network 130 is configured to connect the data access control system 110 and the computer system 120. The network 130 may be a wired or wireless network. Examples of the network 130 include the Internet, an intranet, a WiFi network, a WiMAX network, a mobile telephone network, or a combination thereof.

### Example Process

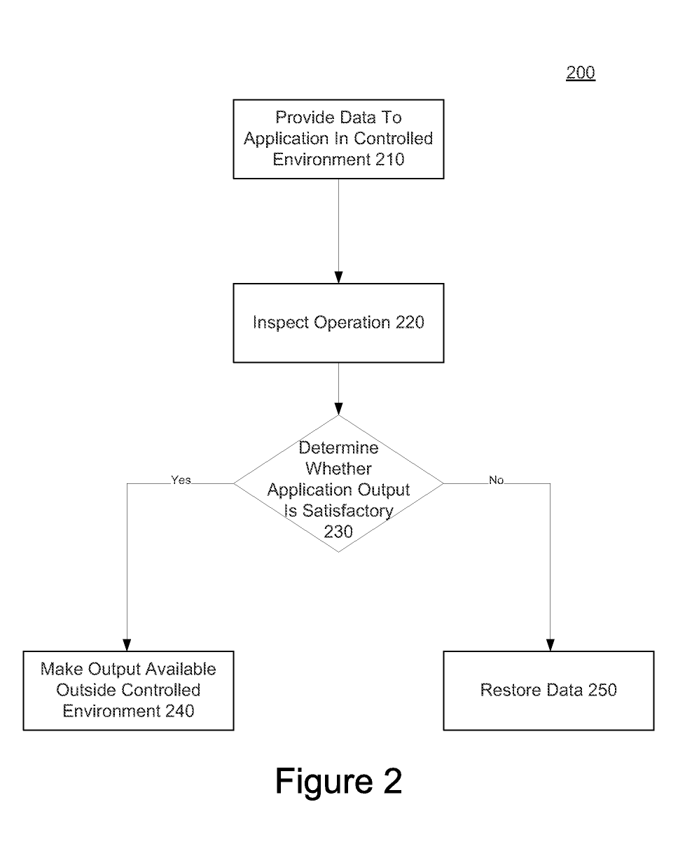

FIG. 2 is a flow diagram that shows an example of a method 200 for the data access control system 110 to prevent a software application from misusing private data. Other examples perform the steps in different orders and/or perform different or additional steps than the ones shown.

The data access control system 110 provides at step 210 data (e.g., private data such as the data owner's scheduling information) to a software application executed in the controlled computing environment 112. The data access control system 110 inspects at step 220 results of operations performed by the application on the data by verifying an output of the application (e.g., communication messages addressed to an outside entity) against a specification for the application. For example, the data access control system 110 verifies that the data accessed by the application are consistent to the input data specified in the specification, verities that the application outputs are in the specified format, and/or verifies that the contents of the outputs are consistent with the specified transformation operations.

The data access control system 110 determines at step 230 whether the application output is satisfactory based on the results of the inspection. If the application output is consistent with the specification, then the application output is determined satisfactory, and the data access control system 110 makes at step 240 the application output available outside the controlled computing environment 112. Otherwise, if the application output is inconsistent with the specification, then the application output is determined not satisfactory, and, as a consequence, the data access control system 110 terminates the application and restores at step 250 the data accessed by the application to its initial status by rolling back changes made by the application. For example, the data access control system 110 may store a backup copy of the data prior to its being accessed by the application, and the data access control system 110 may roll back the changes made by the application by restoring the backup copy of the data.

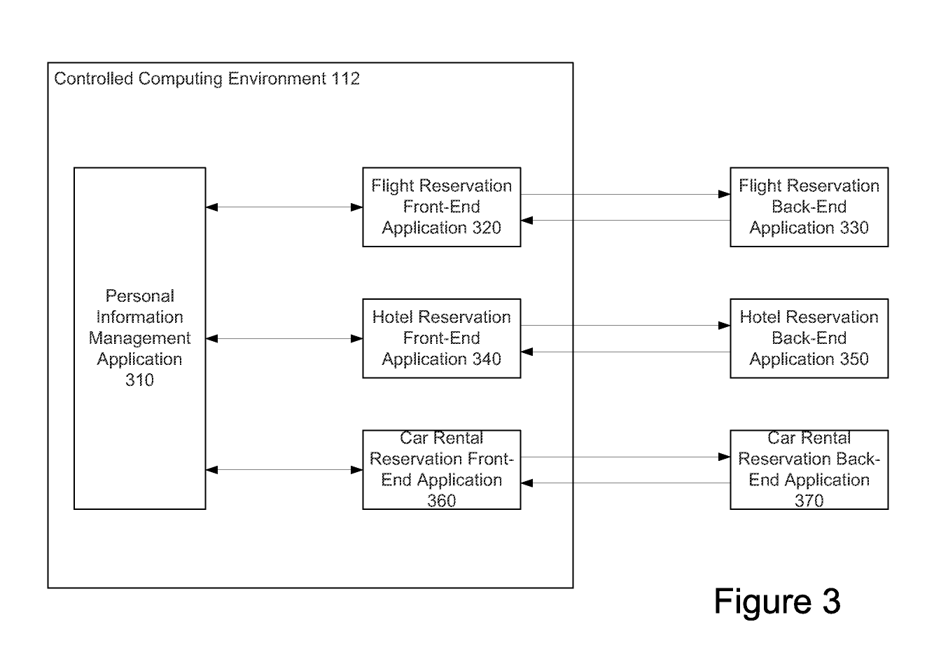

FIG. 3 is a flow diagram illustrating an example process for the data access control system 110 to make reservations for a trip by making available private data to service providers while preventing the service providers from misusing the private data. As shown, a personal information management application 310 executes in the controlled computing environment 112 and has access to a data owner's private data, such as the data owner's name, age, scheduling information (e.g., trip itinerary), and financial information (e.g., credit card number). Also executed in the controlled computing environment 112 are a flight reservation front-end application 320, a hotel reservation front-end application 340, and a car rental reservation front-end application 360 provided by (e.g., downloaded from) a flight reservation web site, a hotel reservation web site, and a car rental reservation web site, respectively.

To find out flights that are suitable to the data owner's itinerary, the flight reservation front-end application 320 communicates with the personal information management application 310 to access the data owner's itinerary, verifies that the traveler is an adult, and transmits the itinerary (or a transformation of the itinerary) to a flight reservation back-end application 330 executed on the flight reservation web site. The output analysis module 114 verifies that the output (e.g., the message to the back-end application 330 containing the itinerary) is consistent with the specification of the front-end application 320, and contains a copy of the itinerary, before allowing the output to be transmitted out of the controlled computing environment 112. The back-end application 330 searches for available flights that fit the user's itinerary, and transmits information about such flights back to the front-end application 320. The front-end application 320 provides information about the available flights to the personal information management application 310, which selects one or more candidate flights from the available flights. Once a candidate flight is selected, the personal information management application 310 engages with the hotel reservation front-end application 340 to find out available hotel options suitable to the user's itinerary and budget. The front-end application 340 accesses the itinerary and other information (e.g., budget, candidate flight, preferred hotel chains), verities that the traveler is an adult, and, after the output analysis module 114 determines the output containing such information (or a transformation of such information) is satisfactory, transmits the output to a hotel reservation back-end application 350. The back-end application 350 searches for available and suitable hotel options, and transmits information about such hotel options back to the front-end application 340. The front-end application 340 provides information about the available hotel options to the personal information management application 310, which selects one or more candidate hotel options. The personal information management application 310 then engages with the car rental reservation front-end application 360 to find out available car rental options. The front-end application 360 accesses the itinerary and other information (e.g., user preferences, candidate flight), verifies that the traveler is an adult, and, after the output analysis module 114 determines the output containing such information (or a transformation of such information) is satisfactory, transmits the output to a car rental reservation back-end application 370. The back-end application 370 searches for available car rental options and transmits such information back to the front-end application 360. The front-end application 360 provides information about the available car rental options to the personal information management application 310, which selects one or more candidate car rental options.

Once candidate flight, hotel, and car rental options are selected, the personal information management application 310 engages the front-end applications 320, 340, 360 to make reservations for the candidate options. The personal information management application 310 provides the flight reservation front-end application 320 with information about the candidate flight along with personal data such as name and/or credit card information. The flight reservation front-end application 320 obtains payment using the credit card information, and encrypts the credit card information using a cryptographic key belonging to an audit system for the flight reservation back-end application 330. After the output analysis module 114 determines an output is satisfactory, the output containing (1) payment information and encrypted credit card information without plain-text credit card information and (2) an aggregated database of traveler ages without individual ages, the front-end application 320 transmits the output to the back-end application 330, which completes the flight reservation for the candidate flight and transmits back to the front-end application 320 a message containing conformation information. The front-end application 320 forwards the confirmation information to the personal information management application 310 to complete the flight reservation process. Similarly, the front-end application 340 and the front-end application 360 obtain the necessary information from the personal information management application 310, communicate with the back-end application 350 and the back-end application 370 to make reservation for the candidate hotel option and car rental option, and forward to the personal information management application 310 confirmation information received from the back-end applications 350, 370, respectively.

If any of the reservation processes did not complete successfully or if any of the outputs was determined unsatisfactory, then the output analysis module 114 can erase a portion or all of the output data produced by the front-end applications 320, 340, 360, and can terminate a portion or all of the front-end applications 320, 340, 360. In addition, instead of engaging with the front-end applications 320, 340, 360 sequentially to make reservations, the personal information management application 310 may engage with them in parallel.

In this example, the controlled computing environment 112 may help to ensure that private information is not revealed until and unless it needs to be revealed. For example, the data owner's name need not be recorded until after it has been confirmed that a suitable flight, hotel option, and car rental option are all available. As another example, the data owner's age need not be disclosed once it has been verified that the owner is an adult, except for being merged into a database of traveler statistics. In addition, the data owner's payment information need not be revealed in unencrypted form once a payment has been authorized, except to auditors.

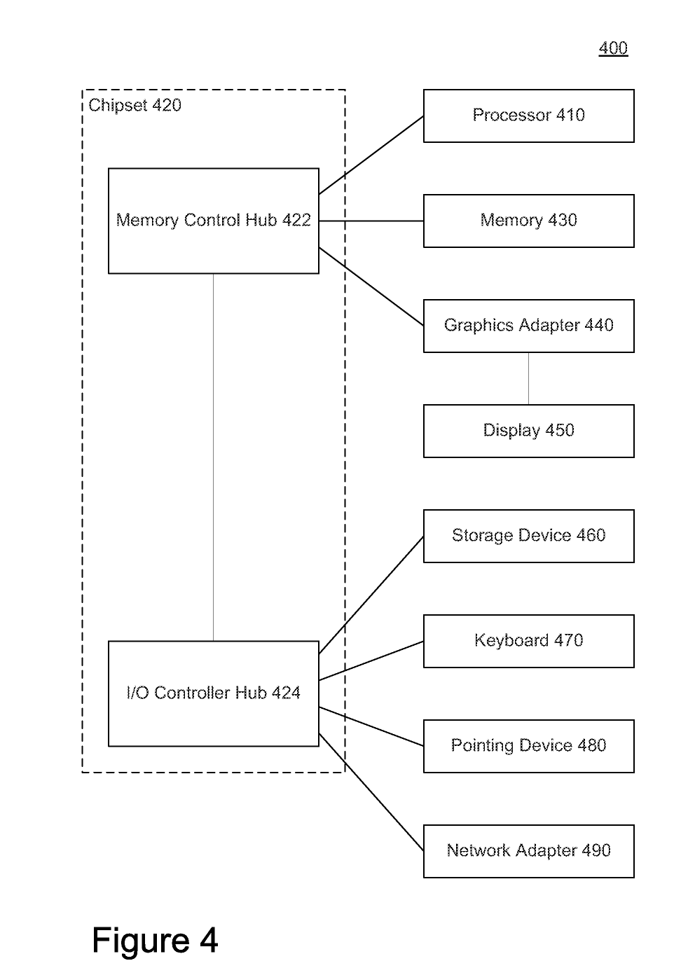

In one example, the entities shown in FIGS. 1-3 are implemented using one or more computer systems. FIG. 4 is a high-level block diagram illustrating an example computer system 400. The computer system 400 includes at least one processor 410 coupled to a chipset 420. The chipset 420 includes a memory controller hub 422 and an input/output (I/O) controller hub 424. A memory 430 and a graphics adapter 440 are coupled to the memory controller hub 422, and a display 450 is coupled to the graphics adapter 440. A storage device 460, a keyboard 470, a pointing device 480, and a network adapter 490 are coupled to the I/O controller hub 424. Other examples of the computer system 400 have different architectures.

The storage device 460 is a non-transitory computer-readable storage medium such as a hard drive, compact disk read-only memory (CD-ROM), DVD, or a solid-state memory device. The memory 430 holds instructions and data used by the processor 410. The pointing device 480 is a mouse, track ball, or other type of pointing device, and is used in combination with the keyboard 470 to input data into the computer system 400. The graphics adapter 440 displays images and other information on the display 450. The network adapter 490 couples the computer system 400 to one or more computer networks.

The computer system 400 is adapted to execute computer program modules for providing functionality described herein. As used herein, the term “module” refers to computer program logic used to provide the specified functionality. Thus, a module can be implemented in hardware, firmware, and/or software. In one example, program modules are stored on the storage device 460, loaded into the memory 430, and executed by the processor 410.

The types of computer systems 400 used by entities can vary depending upon the example and the processing power required by the entity. For example, a source system 110 might comprise multiple blade servers working together to provide the functionality described herein. As another example, a destination system 120 might comprise a mobile telephone with limited processing power. A computer system 400 can lack some of the components described above, such as the keyboard 470, the graphics adapter 440, and the display 450. In addition, one or more of the entities may be implemented in a cloud computing environment (e.g., in which dynamically scalable and perhaps virtualized resources are provided as a service over the Internet such that the cloud computing customers may not own the physical infrastructure serving as host to the software platform in question, but instead rent usage of resources from a third-party provider and consume these resources as a service and pay only for resources used).

One skilled in the art will recognize that the configurations and methods described above and illustrated in the figures are merely examples, and that the described subject matter may be practiced and implemented using many other configurations and methods. It should also be noted that the language used in the specification has been principally selected for readability and instructional purposes, and may not have been selected to delineate or circumscribe the inventive subject matter. Accordingly, the disclosure of the described subject matter is intended to be illustrative, but not limiting, of the scope of the subject matter, which is set forth in the following claims.

What is claimed is:

1. A method for controlling access to data by an application, comprising:
providing a set of data to the application executing in an environment, wherein the application is restricted from making its output available outside the environment;
inspecting a result of an operation performed on the set of data by the application;
determining whether an output of the application is satisfactory having inspected the result of the operation performed on the set of data by the application; and
responsive to determining that the output is satisfactory, making the output available outside the environment.

2. The method of claim 1, further comprising:
providing a second set of data to the application executing in the environment;
inspecting a result of a second operation performed on the second set of data by the application;
determining whether a second output of the application is satisfactory having inspected the result of the second operation performed on the set of data by the application; and
responsive to determining that the second output is not satisfactory, undoing a change made to the second set of data by the application.

3. The method of claim 1, wherein inspecting the result of the operation performed on the set of data by the application comprises:
determining whether the output of the application is consistent with a transformation operation based on a specification of the application,
wherein the output of the application is determined satisfactory responsive to a determination that the output of the application is consistent with the transformation operation.

4. The method of claim 1, wherein making the output available outside the environment comprises permitting the application to communicate with an entity outside the environment.

5. The method of claim 1, further comprising:
providing an assurance about a trustworthiness of the environment to at least one of the following: the application, and an entity associated with the application.

6. The method of claim 1, further comprising:
inspecting a specification of the application to determine whether the specification is satisfactory; and
responsive to determining that the specification is satisfactory, executing the application in the environment and providing the set of data to the application.

7. The method of claim 6, wherein inspecting the specification comprises:
determining whether a transformation operation identified in the specification is adequate for data identified in the specification,
wherein the specification is determined satisfactory responsive to determining that the transformation operation is adequate for the data identified in the specification.

8. A non-transitory computer-readable storage medium having computer program instructions recorded thereon for controlling access to data by an application, the computer program instructions comprising instructions for:
providing a set of data to the application executing in an environment, wherein the application is restricted from making its output available outside the environment;
inspecting a result of an operation performed on the set of data by the application;
determining whether an output of the application is satisfactory having inspected the result of the operation performed on the set of data by the application; and
responsive to determining that the output is satisfactory, making the output available outside the environment.

9. The storage medium of claim 8, wherein the computer program instructions further comprise instructions for:
providing a second set of data to the application executing in the environment;
inspecting a result of a second operation performed on the second set of data by the application;
determining whether a second output of the application is satisfactory having inspected the result of the second operation performed on the set of data by the application; and
responsive to determining that the second output is not satisfactory, undoing a change made to the second set of data by the application.

10. The storage medium of claim 8, wherein inspecting the result of the operation performed on the set of data by the application comprises:
determining whether the output of the application is consistent with a transformation operation based on a specification of the application,
wherein the output of the application is determined satisfactory responsive to a determination that the output of the application is consistent with the transformation operation.

11. The storage medium of claim 8, wherein making the output available outside the environment comprises permitting the application to communicate with an entity outside the environment.

12. The storage medium of claim 8, wherein the computer program instructions further comprise instructions for:
providing an assurance about a trustworthiness of the environment to at least one of the following: the application, and an entity associated with the application.

13. The storage medium of claim 8, wherein the computer program instructions further comprise instructions for:
inspecting a specification of the application to determine whether the specification is satisfactory; and
responsive to determining that the specification is satisfactory, executing the application in the environment and providing the set of data to the application.

14. The storage medium of claim 13, wherein inspecting the specification comprises:
determining whether a transformation operation identified in the specification is adequate for data identified in the specification,
wherein the specification is determined satisfactory responsive to determining that the transformation operation is adequate for the data identified in the specification.

15. A system for controlling access to data by an application, comprising:
an environment within which the application executes, wherein a set of data is provided to the application, and the application is restricted from making its output available outside the environment; and
a module to inspect a result of an operation performed on the set of data by the application, determine whether an output of the application is satisfactory having inspected the result of the operation performed on the set of data by the application, and make the output available outside the environment responsive to determining that the output is satisfactory.
